(19) United States
(12) Patent Application Publication
(10) Pub. No.: US 2014/0069995 A1
(43) Pub. Date: Mar. 13, 2014

(54) Double Postcard With Check

(71) Applicant: NEW JERSEY BUSINESS FORMS, Englewood, NJ (US)

(72) Inventor: David Yost, Roanoke, VA (US)

(73) Assignee: NEW JERSEY BUSINESS FORMS, Englewood, NJ (US)

(21) Appl. No.: 14/022,582

(22) Filed: Sep. 10, 2013

Related U.S. Application Data
(60) Provisional application No. 61/700,157, filed on Sep. 12, 2012.

(51) Int. Cl. B42D 15/04; B42D 15/02; B42D 15/08; B42D 15/00

(52) U.S. Cl. CPC B42D 15/042; B42D 15/0013; B42D 15/02; B42D 15/08
USPC 229/300; 229/92.8; 493/200; 493/397

(57) ABSTRACT

A double postcard with bank check includes a first panel, a second panel, and a third panel. The first and second panels are separated by a first line of weakness. The second and third panels are separated by a second line of weakness. The first panel includes first and second opposing surfaces. A face of a bank check is located on the first opposing surface and an outgoing address is located on the second opposing surface. Related apparatus, systems, techniques, and articles are also described.

### RELATED APPLICATIONS

This application claims priority to U.S. Provisional Patent Application No. 61/700,157, filed Sep. 12, 2012, the contents of which is hereby incorporated by reference in its entirety.

### TECHNICAL FIELD

The subject matter described herein relates to double postcards, specifically double postcards containing one or more checks.

### BACKGROUND

A postcard can be a rectangular piece of material, such as thick paper or thin cardboard, intended for writing and mailing without an envelope. In some places, it is possible to send them for a lower fee than for a letter. The United States Postal Service (USPS) defines a postcard as: rectangular, at least 3+½ inches (88.9 mm) high×5 inches (127 mm) long×0.007 inches (0.178 mm) thick and no more than 4+¼ inches (108 mm) high×6 inches (152.4 mm) long×0.016 inches (0.406 mm) thick.

A double postcard (i.e., a double stamped card or double card) can include two attached cards configured so that they may be sent as a single card. The recipient can separate the two cards and return or mail one of the cards. Typically, a double postcard can include a single piece of material with perforations or other imposed weakness in the middle, which, when folded (or closed), cause the first or interior side of the material to fold upon itself thus hiding any printing on the first side. The second or outer side of the material forms the first post card. Double postcards can include a check or other sensitive information that is hidden when initially mailed.

Double postcards are becoming increasingly popular because of a significant postage savings.

### SUMMARY

In an aspect, a double postcard with bank check includes a first panel, a second panel, and a third panel. The first and second panels are separated by a first line of weakness. The second and third panels are separated by a second line of weakness. The first panel includes first and second opposing surfaces. A face of a bank check is located on the first opposing surface and an outgoing address is located on the second opposing surface.

In another aspect, manufacturing a double postcard with check includes providing a double postcard having a first panel, a second panel, and a third panel. The first panel comprises first and second opposing surfaces. A face of a bank check is located on the first opposing surface. An outgoing address is printed on the second opposing surface.

One or more of the following features can optionally be included in any feasible combination. For example, the outgoing address can be located within a band that is about 2 and ¾ inches from a left edge of the second surface. The second panel can include an intelligent mail barcode. The intelligent mail barcode can be between about 1 and ½ inches and about ⅝ inches from the second line of weakness. The third panel can be between about 3.5 inches by about 6 inches and about 4.25 inches by about 6 inches. The double postcard can be folded at the second line of weakness. The second surface can include a postal permit or stamp located near an edge opposite the outgoing address. The second surface can have located thereon a return address. The return address can be within about 2 and ¾ inches from an edge of the second surface. The outgoing address can be printed on the second surface. The double postcard can include a paper grade equal to or greater than about 0.007 inches. The face of the bank check can include a Magnetic Ink Character Recognition (MICR), the MICR located closer to the first line of weakness than at least one edge of the double postcard.

The outgoing address can be printed within a band that is 2 and ¾ inches from a left edge of the second surface. A postage indicia can be printed on the second surface. A return address can be printed on the second surface. An intelligent mail barcode can be printed on the second panel. the double postcard can be folded at the second line of weakness.

The subject matter described herein provides many advantages. For example, although in no way limiting or for interpreting the claims, double postcards can provide a substantial savings of postage, especially in a large mailing that requires automation (and thus provides postal discounts). The current subject matter can solve USPS layout issues by utilizing the banking regulations for check layout and the USPS regulations for automated mail. Additionally, imaging of the form can be easier without the use of special software as all panels can image in the same orientation of reading.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A is a first side of an example implementation of a double postcard;

FIG. 1B is a second side of the example implementation of the double postcard;

FIG. 2A is an illustration of a first side of an alternative embodiment of a double postcard in accordance with the current subject matter;

FIG. 2B is an illustration of a second side of an alternative embodiment of a double postcard in accordance with the current subject matter; and

FIG. 3 is a process flow diagram 300 illustrating a method of manufacturing or producing a double postcard with bank check.

Like reference symbols in the various drawings indicate like elements.

### DETAILED DESCRIPTION

The current subject matter places, locates, and/or prints postcard elements in/on regions on the back of a check that may have otherwise been blank thereby providing a double postcard with check design that conforms to both banking specifications as well as USPS regulations.

Banking standards provide that the back of a check on the right side (as referenced from a person viewing the front of the check) near the signature endorsement area has a region 2.75 inches wide that can be utilized for other unrelated information. Further, the left side of the check has a region 1.5 inches wide that can be utilized for other unrelated information. In exemplary implementations, postcard elements (e.g., outgoing/return address and post permit of indicia) are placed in these regions.

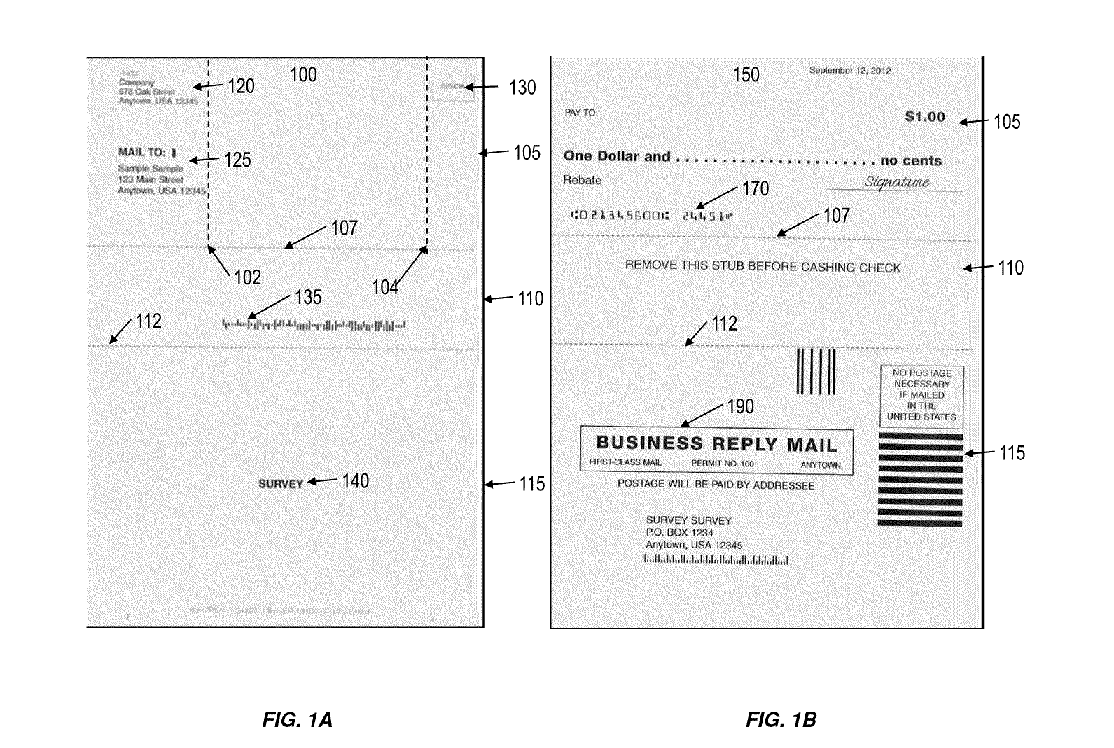

FIG. 1A is a first side 100 of an example implementation of a double postcard. In some embodiments, the first side of the double post card includes at least three distinct panels. Each panel can have two opposing surfaces. The first panel 105 corresponds to a back of a check and can include an area for post elements including the outgoing address 125, the return address 120, and the postal permit or indicia 130 spaced according to USPS regulation. Regions indicated by lines 102 and 104 denote the areas that, since 105 corresponds to the back of a bank check, can be utilized for non-banking data (that is, the region to the left of 102 and the region to the right of 104.) The second panel 110 includes a space for a USPS Intelligent Mail Barcode 135 (IMB). The third panel 115 includes space for additional or auxiliary information 140 such as a survey or other material.

Each panel can be separated by a perforation or other intended weakness or line of weakness. First perforation 107 can separate panel 105 and panel 110. Second perforation 112 can separate panel 110 and panel 115. The IMB 135 can be located closer to the center perforation (second perforation 112) than to an edge of the first panel 105. The double postcard 100 can fold along second perforation 112 and can be sealed using pressure sealing, an adhesive, or other suitable adhering technique.

FIG. 1B is a second side 150 of the double postcard. In some embodiments, the second side of the double post card includes at least three distinct panels that correspond to the panels described with reference to FIG. 1A. The opposite (back) side of panel 105 is shown. As noted above, the front and back of panel 105 forms a banking check. The check can include a Magnetic Ink Character Recognition (MICR) 170, and is a character recognition technology used primarily by the banking industry to facilitate the processing of checks and makes up the routing number and account number at the bottom of a check. The MICR can be located closer to the center line of weakness (first line of weakness 107) than at least one of the edges of the postcard.

The opposite (back) side of panel 110 is shown. The opposite (back) side of panel 115 is shown and includes space for additional or auxiliary information 190 such as reply mail information.

Panel 105 can be separated from the double postcard to form a bank check. The postal elements can stay on the check once separated (e.g., the outgoing address 125, the return address 120, and the postal permit 130). According to bank regulations, the back of a check on the right side (as referenced from a person viewing the front of the check) near the signature endorsement area has a band (i.e., region) 3 inches wide that can be utilized for other unrelated information. In this embodiment, the return address 120 and outgoing address 125 can be placed in this band above the first perforation 107. The entire return address 120 and outgoing address 125 can reside within the band. According to bank regulations, the left side of a check has a band (i.e., region) 1.5 inches wide that can be utilized for other unrelated information. In this embodiment, the postal permit 130 can be located, printed on, or be placed in this 1.5 inch vertical band. The entire postal permit 130 can reside within the band.

The first perforation 107 can be between about ⅝ inch and 1.5 inches from the second perforation 112. Separating first panel 105 and second panel 110 causes the USPS IMB 135 barcode to be removed from the check.

Since the first perforation 107 is placed close to the bottom of the check, in some example embodiments, extra adhesive (e.g., glue) can be located close to a center point of the check. This increases confidentiality and helps to prevent sensitive data from being seen by an individual who has not opened the folded double postcard.

The MICR numbering 170 can be located or printed close to the first perforation 107 to provide a uniform thickness along the MICR 170 edge to enable automatic processing of the check by a bank. The check can be printed head to head to provide a proper layout. This configuration also makes layout easier with software such as Microsoft Word 2010, because fonts do not have to be rotated 180 degrees.

Optionally, the double postcard can include one or more opening perforations 145 placed approximately ⅜ inch to ⅝ inch, (and can preferably be ½ inch) from an edge of the mail piece. The opening perforations 145 can make opening easier, e.g., on postcard sizes over 3.75 inches by 6 inch.

Optionally, adhesive or glue can be placed on the face of the check, near the top edge (i.e., that is the second side of panel 105 near the top edge of the check).

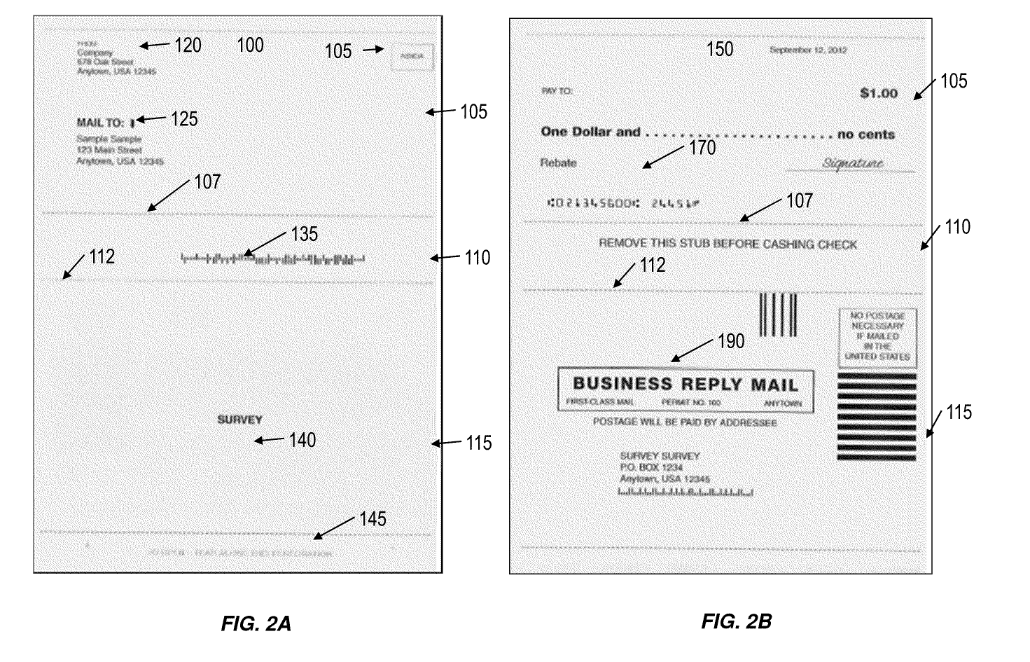

FIGS. 2A and 2B are illustrations of an alternative embodiment of a double postcard in accordance with the current subject matter. FIGS. 2A and 2B include two opening perforations 145. The additional perforations can aid a recipient of the double postcard in opening the double postcard. Additionally, first perforation 107 and second perforation 112 are closer together.

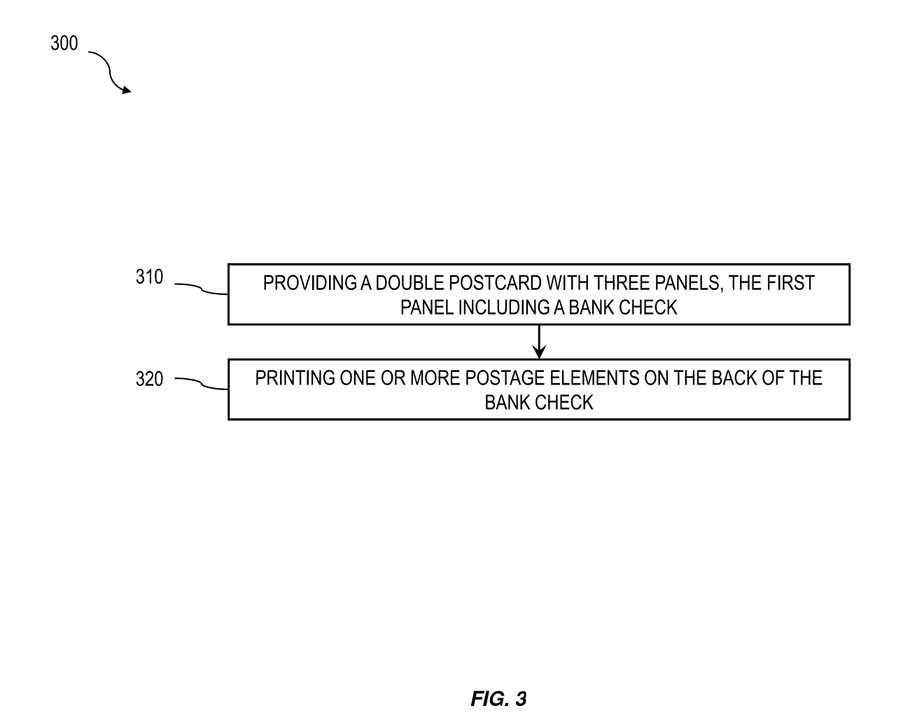

FIG. 3 is a process flow diagram 300 illustrating a method of manufacturing or producing a double postcard with bank check. At 310, a double postcard is provided having a first panel 105, a second panel 110, and a third panel 115. The first panel can include a bank check. Lines of weaknesses (e.g., perforations) can separate the panels.

At 320, one or more postage elements are printed on the back of the bank check. The postage elements can include an outgoing address 125, a return address 120, and postage indicia or stamp 130. The printing can be performed by, for example, a printing machine, printing press, or other printing apparatus.

By way of reference, USPS regulations can be found, for example, in “Domestic Mail Manual” published by the US Postal Service. Banking regulations for check endorsement and format layout can be found, for example, in ANSI Standard X9.7 and X9.100-200.

Although a few variations have been described in detail above, other modifications are possible. Other embodiments may be within the scope of the following claims.

What is claimed is:

1. A double postcard with bank check comprising:
a first panel;
a second panel; and
a third panel;
wherein the first and second panel are separated by a first line of weakness, the second and third panel are separated by a second line of weakness, the first panel comprising first and second opposing surfaces, wherein a face of a bank check is located on the first opposing surface, and an outgoing address is located on the second opposing surface.

2. The double postcard of claim 1, wherein the outgoing address is located within a band that is about 2 and ¾ inches from a left edge of the second surface.

3. The double postcard of claim 1, wherein the second panel includes an intelligent mail barcode.

4. The double postcard of claim 3, wherein the intelligent mail barcode is between about 1 and ½ inches and about ⅝ inches from the second line of weakness.

5. The double postcard of claim 1, wherein the third panel is between about 3.5 inches by about 6 inches and about 4.25 inches by about 6 inches.

6. The double postcard of claim 1, wherein the double postcard is folded at the second line of weakness.

7. The double postcard of claim 1, wherein the second surface includes a postal permit or stamp located near an edge opposite the outgoing address.

8. The double postcard of claim 1, wherein the second surface has located thereon a return address.

9. The double postcard of claim 8, wherein the return address is within about 2 and ¾ inches from an edge of the second surface.

10. The double postcard of claim 1, wherein the outgoing address is printed on the second surface.

11. The double postcard of claim 1, wherein the double postcard includes a paper grade equal to or greater than about 0.007 inches.

12. The double postcard of claim 1, wherein the face of the bank check includes a Magnetic Ink Character Recognition (MICR), the MICR located closer to the first line of weakness than at least one edge of the double postcard.

13. A method of manufacturing a double postcard with check comprising:
providing a double postcard having a first panel, a second panel, and a third panel, wherein the first panel comprises first and second opposing surfaces, wherein a face of a bank check is located on the first opposing surface; and
printing, on the second opposing surface, an outgoing address.

14. The method of claim 13, wherein the outgoing address is printed within a band that is 2 and ¾ inches from a left edge of the second surface.

15. The method of claim 13, wherein the first panel and second panel are separated by a first line of weakness, and the second and third panel are separated by a second line of weakness.

16. The method of claim 13, wherein the second line of weakness is between is between about 1 and ½ inches and about ⅝ inches from the first line of weakness.

17. The method of claim 13, further comprising printing, on the second surface, a postage indicia.

18. The method of claim 13, further comprising printing, the on the second surface, a return address.

19. The method of claim 18, wherein the return address is within about 2 and ¾ inches from an edge of the second surface.

20. The method of claim 13, further comprising: printing, on the second panel, an intelligent mail barcode.

21. The method of claim 13, wherein the third panel is between about 3.5 inches by about 6 inches and about 4.25 inches by about 6 inches.

22. The method of claim 13, wherein the double postcard includes a paper grade equal to or greater than about 0.007 inches.

23. The method of claim 13, further comprising folding the double postcard at the second line of weakness.

24. The method of claim 13, wherein the face of the bank check includes a Magnetic Ink Character Recognition (MICR), the MICR located closer to the first line of weakness than at least one edge of the double postcard.
